(19) United States
(12) Patent Application Publication
(10) Pub. No.: US 2025/0305713 A1
(43) Pub. Date: Oct. 2, 2025

(54) AIR-CONDITIONING OUTLET DEVICE

(71) Applicant: MORIROKU TECHNOLOGY COMPANY, LTD., Tokyo (JP)

(72) Inventors: Ryo Sakurai, Tokyo (JP); Mirei Uehara, Tokyo (JP)

(21) Appl. No.: 19/084,630

(22) Filed: Mar. 19, 2025

(30) Foreign Application Priority Data
Mar. 27, 2024 (JP) 2024-050983

(51) Int. Cl. F24F 13/08

(52) U.S. Cl. CPC F24F 13/082

(57) ABSTRACT

An air-conditioning outlet device includes a housing in which a blowout port is formed; a fin body provided inside the housing; and a first fin mechanism that displaces the fin body in an air flow direction. The housing includes a narrow portion having an area narrower than an area of the blowout port. The fin body is located between the blowout port and the narrow portion in a normal mode, and includes a tapered portion of which a width in a width direction increases as the tapered portion extends from an upstream side toward a downstream side.

### FIELD OF THE INVENTION

The present invention relates to an air-conditioning outlet device.

### BACKGROUND

As a conventional technique related to an air-conditioning outlet device used in vehicles, there is a technique disclosed in Japanese Unexamined Patent Publication No. H5-203252.

As illustrated in Japanese Unexamined Patent Publication No. H5-203252, an air-conditioning outlet device includes a housing in which a blowout port is formed at a downstream end of the housing, and a fin mechanism provided inside the housing and capable of changing the direction of a flow path through rotation.

### SUMMARY

In the housing of the air-conditioning outlet device disclosed in Japanese Unexamined Patent Publication No. H5-203252, the flow path area of the blowout port is narrow. As illustrated in FIG. 3 of Japanese Unexamined Patent Publication No. H5-203252, the air speed is increased at the blowout port by narrowing the flow path area of the blowout port. Since the air speed increases at the blowout port located at a position closest to an occupant, the occupant is locally hit by high-speed air, so that the occupant feels uncomfortable, which is a concern. There is room for improvement in terms of comfort.

According to the present disclosure, there is provided an air-conditioning outlet device including: a housing into which air is blown, and in which a blowout port that blows out the air is formed at a downstream end of the housing with reference to a flow direction of the blown air; and a fin body displaceably provided inside the housing. The housing includes a narrow portion having an area narrower than an area of the blowout port. The blowout port has a substantially rectangular shape. When a direction parallel to long sides of the blowout port is defined as a first direction and a direction parallel to short sides that are sides shorter than the long sides is defined as a second direction, the fin body is provided along the first direction, is located between the blowout port and the narrow portion in a normal mode, and includes a tapered portion of which a width in the second direction increases as the tapered portion extends from an upstream side toward a downstream side.

According to the present disclosure, it is possible to provide the air-conditioning outlet device capable of improving comfort.

### BRIEF DESCRIPTION OF THE DRAWINGS

FIG. 1 is a perspective view of an air-conditioning outlet device according to an embodiment when viewed from above;

FIG. 2 is a perspective view of the air-conditioning outlet device illustrated in FIG. 1 when viewed from below;

FIG. 3 is a cross-sectional view taken along line 3-3 in FIG. 1;

FIG. 4 is a view schematically illustrating a fin body and a first fin mechanism illustrated in FIG. 3;

FIG. 5 is a view schematically illustrating a second fin mechanism illustrated in

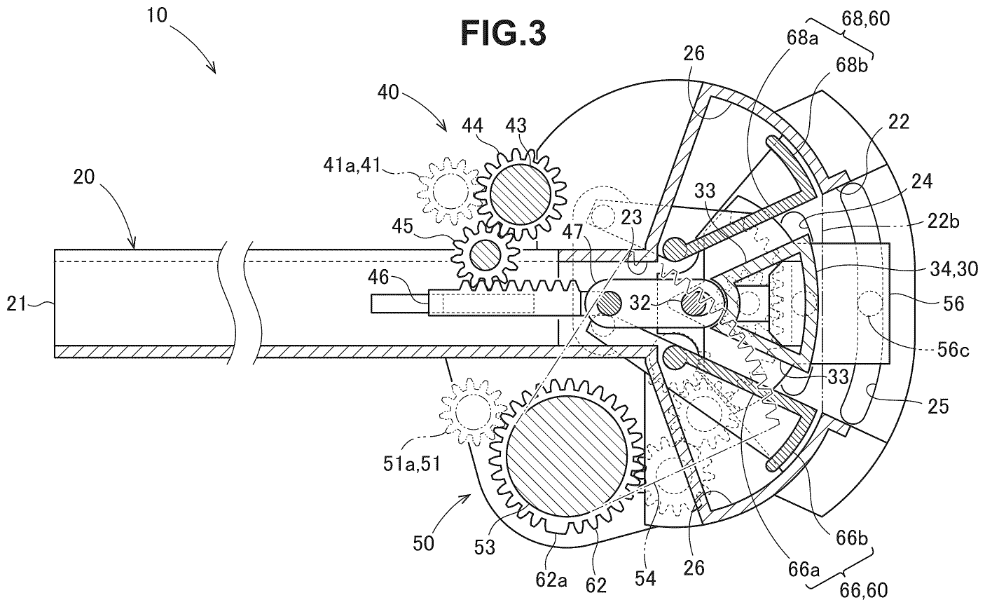

FIG. 3;

FIG. 6 is a view schematically illustrating an air guide mechanism illustrated in FIG. 3;

FIG. 7A is a view for describing an action of the air-conditioning outlet device in a normal mode, and FIG. 7B is a view for describing an action of the air-conditioning outlet device in an air-blowing stop mode;

FIG. 8A is a view for describing an action of the air-conditioning outlet device in a downward air-blowing mode, and FIG. 8B is a view for describing an action of the air-conditioning outlet device in a first central air-blowing mode; and

FIG. 9A is a view for describing an action of the air-conditioning outlet device in an upward air-blowing mode, and FIG. 9B is a view for describing an action of the air-conditioning outlet device in a second central air-blowing mode.

### DETAILED DESCRIPTION

An embodiment of the invention will be described below with reference to the accompanying drawings. The mode illustrated in the accompanying drawings is one example of the invention, and the invention is not limited to the mode.

### Embodiment

An embodiment will be described with reference to the drawings.

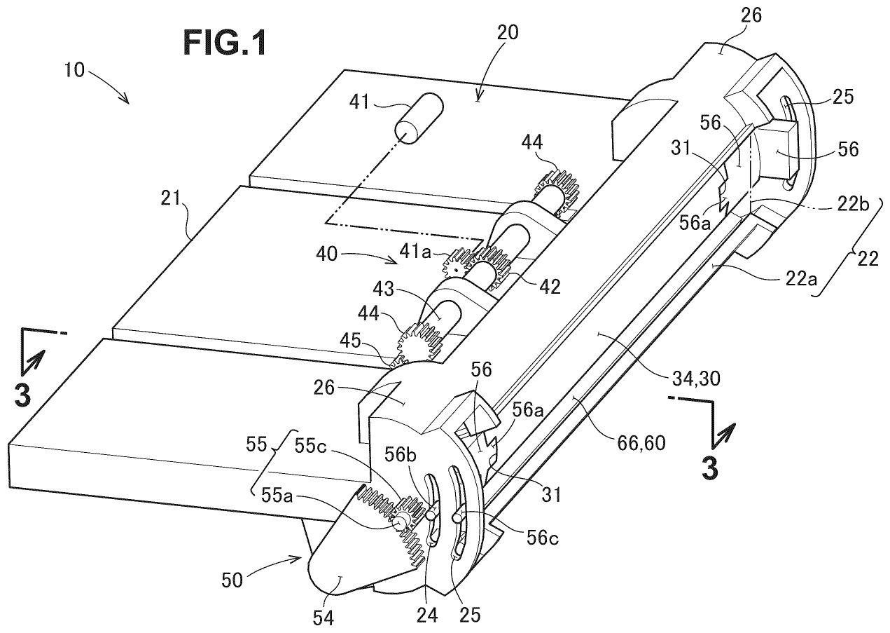

Referring to FIG. 1, an air-conditioning outlet device 10 is used as an outlet device for an air conditioner for a vehicle. The air-conditioning outlet device 10 is provided, for example, in a front portion of a passenger compartment and blows air toward occupants.

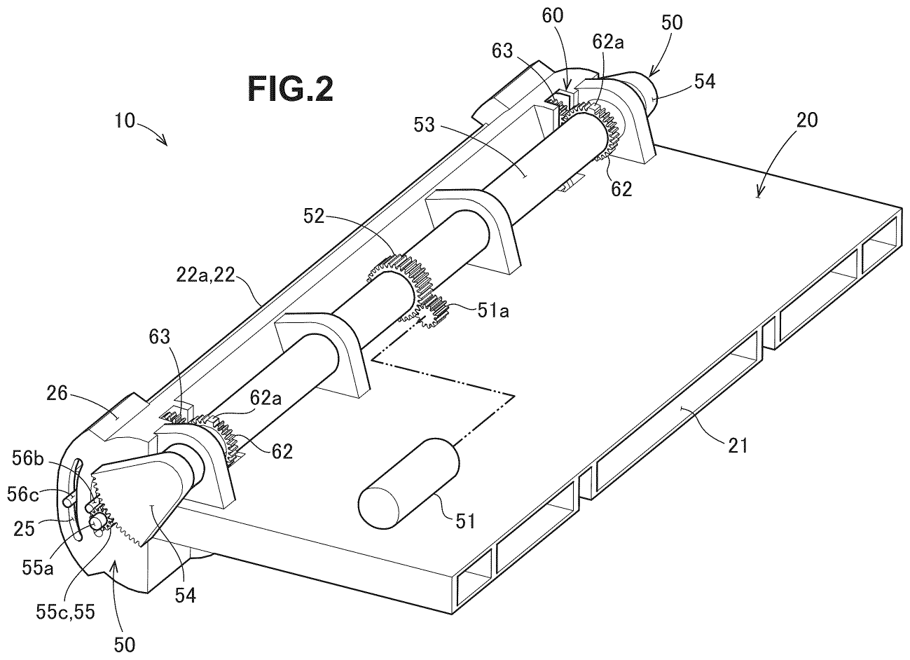

Referring to FIG. 2 and FIG. 3, the air-conditioning outlet device 10 includes a housing 20 into which air is blown; a fin body 30 provided inside the housing 20; a first fin mechanism 40 that displaces the fin body 30 along an air blowing direction; a second fin mechanism 50 that displaces the fin body 30 in an up-down direction; and an air guide mechanism 60 that is provided to be displaceable toward the fin body 30, and that guides the direction of the air that is blown out.

The housing 20 includes an introduction port 21 through which the blown air is introduced; a blowout port 22 that faces the inside of the passenger compartment, and that blows out the air toward the passenger compartment; a narrow portion 23 formed between the introduction port 21 and the blowout port 22 and having an area narrower than the area of the blowout port 22; guide slits 24 and 25 that are slit-shaped holes formed on side surfaces, and that guide the second fin mechanism 50; and a movable wall storage 26 that bulges out in the up-down direction so as to be able to accommodate a part of the air guide mechanism 60.

Referring to FIG. 1, the blowout port 22 has a substantially rectangular shape. Hereinafter, a direction parallel to long sides 22a of the blowout port 22 (a vehicle width direction in the present embodiment) is referred to as a first direction, and a direction parallel to short sides 22b that are sides shorter than the long sides 22a (the up-down direction in the present embodiment) is referred to as a second direction.

In the case of the air-conditioning outlet device 10 in which the blowout port 22 is long up and down, the first direction is the up-down direction, and the second direction is the vehicle width direction (and/or a front-rear direction).

The fin body 30 is provided along the first direction. A portion of the fin body 30 facing the second fin mechanism 50 is formed in a recessed shape, and serves as a connected portion 31 connected to the second fin mechanism 50. When the fin body 30 is in a normal mode, the fin body 30 is connected to the second fin mechanism 50. The connected portion 31 may protrude in a protruding shape toward the second fin mechanism 50.

Referring to FIG. 3, in the normal mode, the fin body 30 is located between the narrow portion 23 and the blowout port 22 and at substantially the center of the blowout port 22 with respect to the second direction. The fin body 30 has a shape in which a substantially fan-shaped cross-section extends in the first direction. The fin body 30 includes a fin body pin 32 that is a pin formed at an upstream end of the fin body 30, and that is connected to the first fin mechanism 40; tapered portions 33 and 33 extending to widen as the tapered portions 33 and 33 extend downstream from the fin body pin 32; and a fin body arc surface 34 formed in an arc shape so as to connect downstream ends s of the tapered portions 33 and 33.

Referring to FIG. 1, the first fin mechanism 40 includes, for example, a first motor 41 that is a stepping motor that operates when energized; a 1-1 gear 42 that is a gear that rotates when the first motor 41 operates; a first shaft 43 that is a shaft penetrating through the 1-1 gear 42 and rotatably supported by the housing 20; 1-2 gears 44 that are gears fixed to both ends of the first shaft 43, and that rotate when the 1-1 gear 42 rotates; and 1-3 gears 45 that are gears meshing with the 1-2 gears 44.

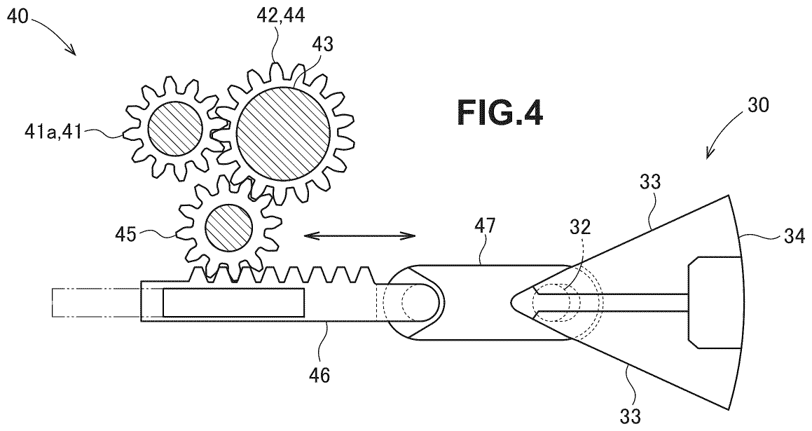

Referring to FIG. 4, the first fin mechanism 40 further includes a rack 46 that meshes with the 1-3 gear 45 to convert rotational motion into linear motion, and a first link member 47 that is a link that connects the rack 46 to the fin body 30.

A gear provided on the first motor 41 is referred to as a first drive gear 41a for transmitting the driving force of the first motor 41.

A motor other than a stepping motor can be used as the first motor 41.

When the first motor 41 is operated based on information from a temperature sensor or an operation by an occupant, the 1-1 gear 42, the first shaft 43, the 1-2 gears 44, and the 1-3 gears 45 rotate. Accordingly, the rack 46 is displaced in the air blowing direction, and the fin body 30 is displaced in the air blowing direction via the first link member 47.

Referring to FIG. 2, the second fin mechanism 50 includes, for example, a second motor 51 that is a stepping motor that operates when energized; a 2-1 gear 52 that is a gear that rotates when the second motor 51 operates; a second shaft 53 that is a shaft penetrating through the 2-1 gear 52 and rotatably supported by the housing 20; fan-shaped gears 54 that are fixed to both ends of the second shaft 53, and that rotate when the 2-1 gear 52 rotates; and 2-3 gears 55 that are gears meshing with the fan-shaped gears 54.

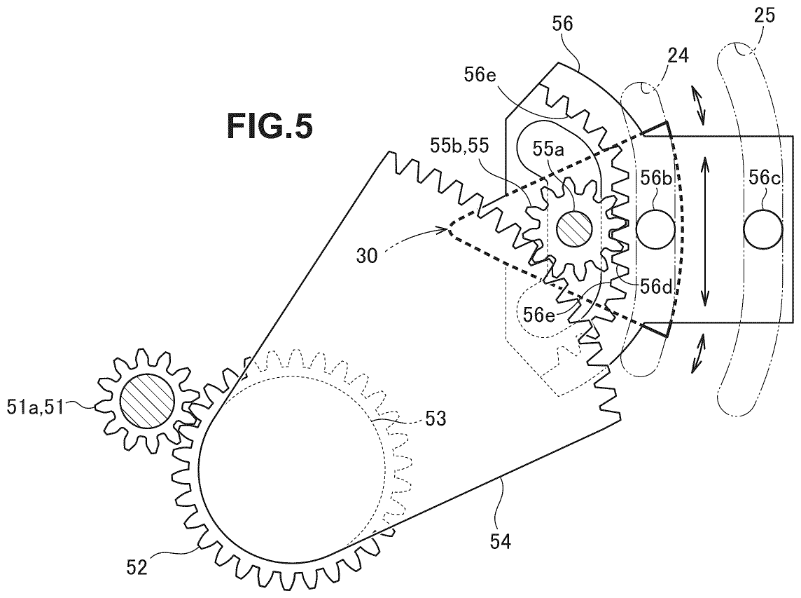

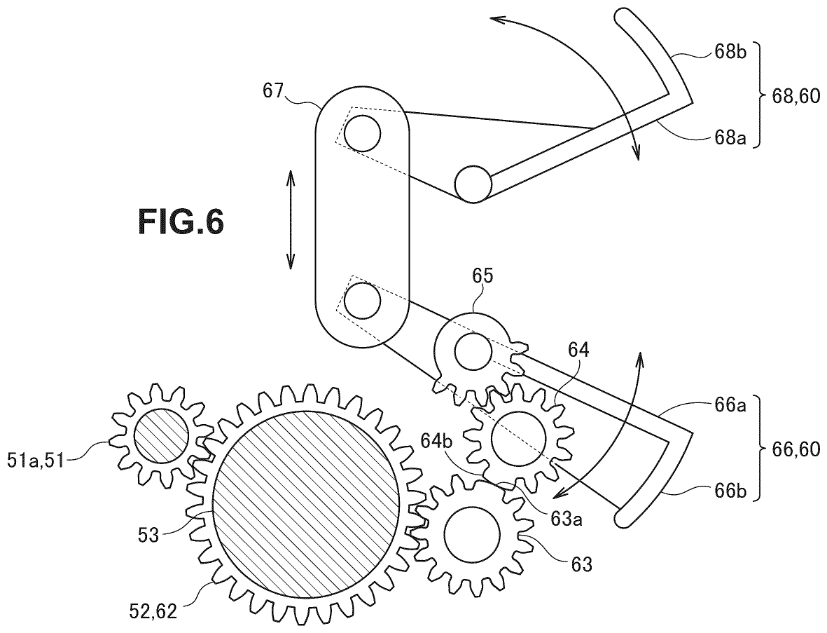

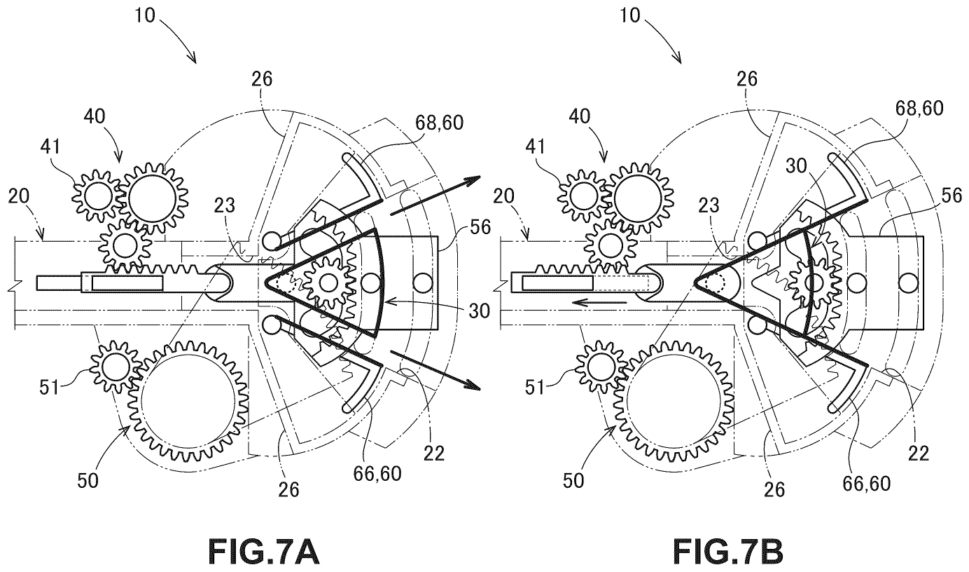

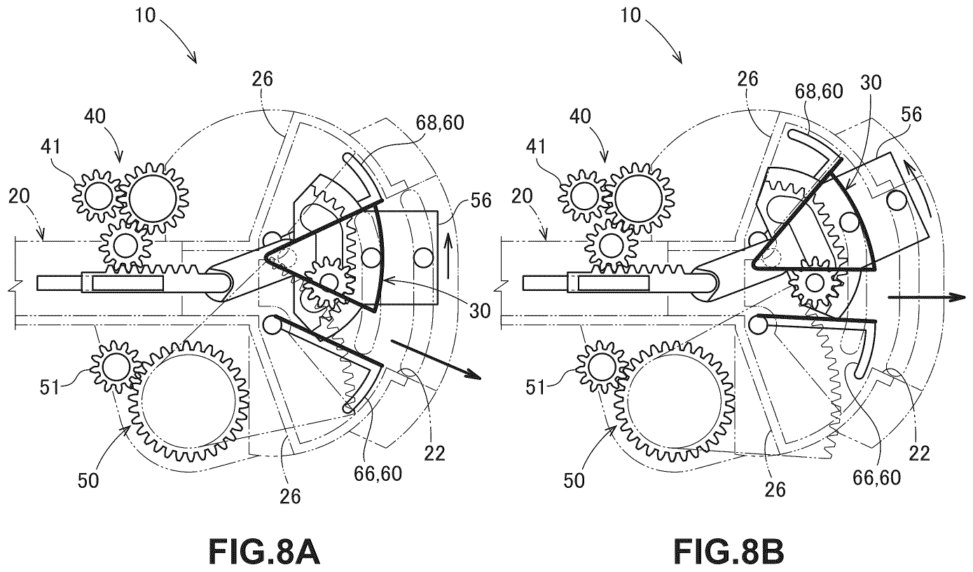

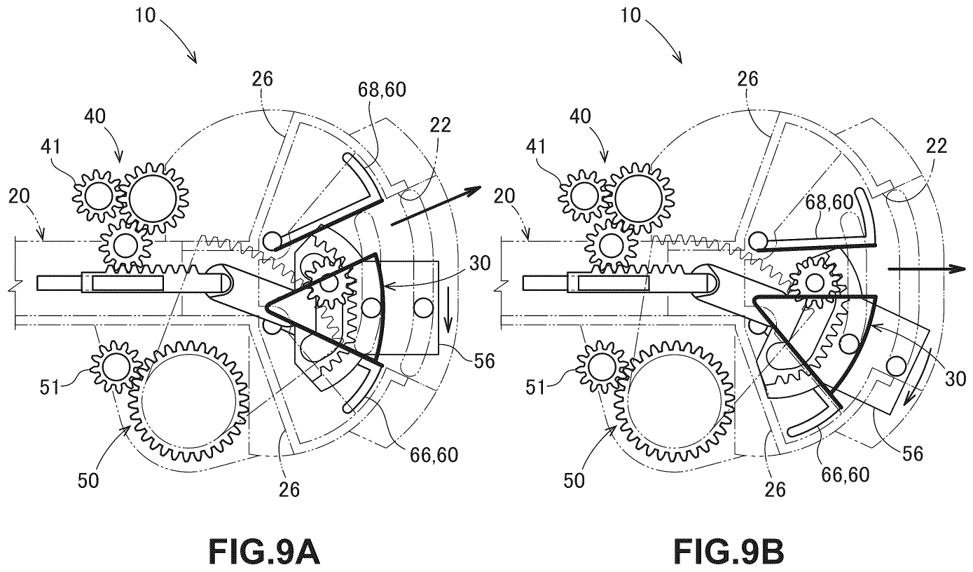

Referring to FIG. 5, the second fin mechanism 50 further includes a fin support 56 meshing with the 2-3 gear 55 and capable of supporting the fin body 30.

Hereinafter, a gear provided on the second motor 51 may be referred to as a drive gear 51a for transmitting the driving force of the motor.

The 2-3 gear 55 is configured such that two gears 55b and 55c (refer to FIG. 1 for 55c) are provided on one gear shaft 55a. The gear shaft 55a penetrates through the housing 20, and is rotatably provided. One gear 55c is provided outside the housing 20, and the other gear 55b is provided inside the housing 20.

Referring to FIG. 1, the fin support 56 includes a connecting portion 56a extending in the first direction and connected to the connected portion 31 in the normal mode. When the connected portion 31 is formed in a protruding shape, the connecting portion 56a may be formed in a recessed shape so as to surround the connected portion 31.

In addition, the fin support 56 includes support pins 56b and 56c having a pin shape and inserted into the guide slits 24 and 25.

Referring to FIG. 5, the fin support 56 includes a linear gear 56d which is a gear meshing with the 2-3 gear 55 and in which teeth are linearly disposed, and arc gears 56e that are gears meshing with the 2-3 gear 55 and in which teeth are disposed in an arc shape. The arc gears 56e are provided continuously from both ends of the linear gear 56d.

When the second motor 51 is operated based on information from the temperature sensor or an operation by the occupant, the 2-1 gear 52, the fan-shaped gears 54, and the 2-3 gears 55 rotate. Accordingly, the fin support 56 is displaced in the second direction. When the linear gear 56d is meshed with the 2-3 gear 55, the fin support 56 is displaced linearly in the second direction. When the arc gear s 56e is meshed with the 2-3 gear 55, the fin support 56 swings in an arc shape in the second direction and the air blowing direction.

Referring to FIG. 2, the air guide mechanism 60 includes the second motor 51; the 2-1 gear 52; the second shaft 53; 3-2 gears 62 that are gears fixed to the second shaft 53; and 3-3 gears 63 that are gears meshing with the 3-2 gears 62.

Referring to FIG. 6, the air guide mechanism 60 further includes a 3-4 gear 64 that is a gear meshing with the 3-3 gear 63; a sector gear 65 that is a sector gear meshing with the 3-4 gear 64; a first guide fin 66 connected to the sector gear 65 and capable of swinging around the connected portion; a guide link member 67 connected to the first guide fin 66; and a second guide fin 68 that is connected to the guide link member 67, and that swings in conjunction with the first guide fin 66.

The second motor 51, the 2-1 gear 52, and the second shaft 53 are components shared with the second fin mechanism 50.

The 3-2 gears 62, the 3-3 gears 63, and the 3-4 gear 64 can be referred to as driven gears 62 to 64 that are driven by the drive gear 51a. Each of the driven gears 62 to 64 may have a portion in which no teeth are formed. A region of the 3-3 gear 63 where no teeth are formed is referred to as a first intermittent portion 63a, and a region of the 3-4 gear 64 where no teeth are formed is referred to as a second intermittent portion 64b.

Referring to FIG. 3, the first guide fin 66 includes an inner wall 66a extending along the tapered portion 33 from the narrow portion 23 to the blowout port 22, and a guide fin end surface 66b extending from a tip of the inner wall 66a and formed in an arc shape. The shape of the guide fin end surface 66b is a shape conforming to a peripheral edge of the blowout port 22. In the normal mode, the guide fin end surface 66b is stored in the movable wall storage 26.

The second guide fin 68 includes an inner wall 68a extending along the tapered portion 33 from the narrow portion 23 to the blowout port 22, and a guide fin end surface 68b extending from a tip of the inner wall 68a and formed in an arc shape. The shape of the guide fin end surface 68b is a shape conforming to the peripheral edge of the blowout port 22. In the normal mode, the guide fin end surface 68b is stored in the movable wall storage 26.

Hereinafter, the first guide fin 66 and the second guide fin 68 may be collectively referred to as the guide fins 66 and 68.

Referring to FIG. 6, in a state where the teeth of all the gears are meshed with each other, the 2-1 gear 52, when the second motor 51 operates based on information from the temperature sensor or an operation by the occupant, the 3-2 gear 62, the 3-3 gear 63, the 3-4 gear 64, and the sector gear 65 rotate. As the sector gear 65 rotates, the first guide fin 66 swings around an end (a portion to which the sector gear 65 is attached) of the inner wall 66a. The guide link member 67 connected to an end of the first guide fin 66 moves in conjunction with the first guide fin 66, and swings the second guide fin 68. The second guide fin 68 swings around an end of the inner wall 68a. The first guide fin 66 and the second guide fin 68 swing while maintaining substantially the same distance therebetween.

When the 3-3 gear 63 rotates, the first intermittent portion 63a is displaced to a position closest to the 3-4 gear 64. Accordingly, the first intermittent portion 63a and the second intermittent portion 64b face each other. In a state where the first intermittent portion 63a and the second intermittent portion 64b face each other, the driving force of the 3-3 gear 63 is not transmitted to the 3-4 gear 64, and only the 3-3 gear 63 rotates. While the 3-4 gear 64 is not in rotation, the sector gear 65 to the guide fins 66 and 68 are not displaced either. When the 3-3 gear 63 continues to rotate and the tooth of the 3-3 gear 63 meshes with the adjacent tooth of the second intermittent portion 64b, the 3-3 gear 63 to the guide fins 66 and 68 are displaced.

Referring also to FIG. 5, a position where each of the intermittent portions 63a and 64b is formed corresponds to the position where the linear gear 56d is formed. Accordingly, even while the second motor 51 is in operation, the guide fins 66 and 68 can be prevented from operating.

In more detail, while the 2-3 gear 55 is meshed with the linear gear 56d and linearly displaces the fin support 56 in the second direction, the guide fins 66 and 68 do not operate. While the 2-3 gear 55 is meshed with the arc gears 56e and swings the fin support 56, the guide fins 66 and 68 operate.

Next, actions of the air-conditioning outlet device 10 will be described.

Referring to FIG. 7A, FIG. 7A illustrates the air-conditioning outlet device 10 in the normal mode. In the normal mode, the fin body 30 is located between the narrow portion 23 and the blowout port 22 and substantially in the middle of a flow path with respect to the second direction. In the normal mode, the air to be blown is divided into upper and lower airflows by the fin body 30, and the air is blown out upward and downward from the blowout port 22.

The two divided airflows are blown out upward and downward from the blowout port 22, namely, in directions away from each other; however, since the air pressure in a central region (downstream of the fin body arc surface 34) interposed between the two airflows decreases, parts of the two airflows are suctioned into the central region, and are bent to approach each other. Therefore, the air diffuses and can be blown over a wide region including the central region.

Referring to FIG. 7B, FIG. 7B illustrates the air-conditioning outlet device 10 in an air-blowing stop mode. When a operation mode is switched from the normal mode (refer to FIG. 7A) to the air-blowing stop mode, the first fin mechanism 40 is operated to displace the fin body 30 toward an upstream side. The fin body 30 comes into contact with the narrow portion 23, so that the flow path is blocked, and the air blowing stops. Namely, the air is no longer blown out from the blowout port 22.

The fin body 30 can also be used at any intermediate position between a position in FIG. 7A and a position in FIG. 7B (between a most downstream position and a position where the fin body 30 comes into contact with the narrow portion 23).

In addition, as long as the air blowing can be stopped by blocking the flow path using the fin body 30, the fin body 30 may come into contact with a portion other than the narrow portion 23. For example, the fin body 30 may come into contact with an upstream end of the first guide fin 66 and an upstream end of the second guide fin 68. It is sufficient if, when the fin body 30 is displaced from the normal mode toward the upstream side, the fin body 30 can come into contact with and block the flow path.

Referring to FIG. 1, in the air-blowing stop mode, the connected portion 31 slides toward the upstream side with respect to the connecting portion 56a. When the operation mode returns from the air-blowing stop mode to the normal mode, the connected portion 31 is connected to the connecting portion 56a.

Referring to FIG. 8A, FIG. 8A illustrates the air-conditioning outlet device 10 in a downward air-blowing mode. When the operation mode is changed from the normal mode (refer to FIG. 7A) to the downward air-blowing mode, the second fin mechanism 50 is operated to displace the fin support 56 linearly upward. The fin body 30 supported by the fin support 56 is also displaced linearly upward. In the downward air-blowing mode, the air is blown out downward from between a lower surface of the fin body 30 and the first guide fin 66.

Referring also to FIG. 6, when the operation mode is changed from the normal mode to the downward air-blowing mode, even if the second motor 51 operates, the guide fins 66 and 68 do not operate. When the operation mode is changed from the normal mode to the downward air-blowing mode, the first intermittent portion 63a and the second intermittent portion 64b are located to face each other, and the driving force of the second motor 51 is not transmitted to the guide fins 66 and 68.

Referring to FIG. 8B, FIG. 8B illustrates the air-conditioning outlet device 10 in a first central air-blowing mode. When the operation mode is changed from the downward air-blowing mode (refer to FIG. 8A) to the first central air-blowing mode, the second fin mechanism 50 and the air guide mechanism 60 are operated to swing the fin support portion 56 upward. The fin body 30 supported by the fin support 56 also swings upward. A part of the fin body 30 and the second guide fin 68 are stored inside the movable wall storage 26. Meanwhile, the inner wall 66a of the first guide fin 66 advances to an extension line from the upstream flow path. The air is blown out substantially horizontally from between the lower surface of the fin body 30 and the first guide fin 66. At this time, at least a part of the guide fin end surface 66b is visible to the occupant, and covers a region between a downstream end of the inner wall 66a of the guide fin 66 and an opening end of the blowout port 22.

Referring to FIG. 9A, FIG. 9A illustrates the air-conditioning outlet device 10 in an upward air-blowing mode. When the operation mode is changed from the normal mode (refer to FIG. 7A) to the upward air-blowing mode, the second fin mechanism 50 is operated to displace the fin support 56 linearly downward. The fin body 30 supported by the fin support 56 is also displaced linearly downward. In the upward air-blowing mode, the air is blown out upward from between an upper surface of the fin body 30 and the second guide fin 68.

Referring also to FIG. 6, when the operation mode is changed from the normal mode to the upward air-blowing mode, even if the second motor 51 is operated, the guide fins 66 and 68 do not operate. When the operation mode is changed from the normal mode to the upward air-blowing mode, the first intermittent portion 63a and the second intermittent portion 64b are located to face each other, and the driving force of the second motor 51 is not transmitted to the guide fins 66 and 68.

Referring to FIG. 9B, FIG. 9B illustrates the air-conditioning outlet device 10 in a second central air-blowing mode. When the operation mode is changed from the upward air-blowing mode (refer to FIG. 9A) to the second central air-blowing mode, the second fin mechanism 50 and the air guide mechanism 60 are operated to swing the fin support 56 downward. The fin body 30 supported by the fin support 56 also swings downward. A part of the fin body 30 and the first guide fin 66 are stored inside the movable wall storage 26. Meanwhile, the inner wall 68a of the second guide fin 68 advances to an extension line from the upstream flow path. The air is blown out substantially horizontally from between the upper surface of the fin body 30 and the second guide fin 68. At this time, at least a part of the guide fin end surface 68b is visible to the occupant, and covers a region between a downstream end of the inner wall 68a of the guide fin 68 and the opening end of the blowout port 22.

The air-conditioning outlet device 10 described above will be summarized below.

Referring to FIG. 3, in a first aspect, the air-conditioning outlet device 10 includes the housing 20 into which air is blown, and in which the blowout port 22 that blows out the air is formed at the downstream end of the housing 20 with reference to a flow direction of the blown air; and the fin body 30 displaceably provided inside the housing 20. The housing 20 includes the narrow portion 23 in which an area through which the air is blown is smaller than an area of the blowout port 22.

Referring also to FIG. 1, the blowout port 22 has a substantially rectangular shape. When the direction parallel to the long sides 22a of the blowout port 22 is defined as the first direction and the direction parallel to the short sides 22b that are sides shorter than the long sides 22a is defined as the second direction, the fin body 30 is provided along the first direction, is located between the blowout port 22 and the narrow portion 23 in the normal mode, and includes the tapered portion 33 of which a width in the second direction increases as the tapered portion 33 extends from the upstream side toward a downstream side.

Referring to FIG. 7A and 7B, when a state where the blowing out of the air from the blowout port 22 is stopped is defined as the air-blowing stop mode (refer to FIG. 7B), a change from the normal mode (refer to FIG. 7A) to the air-blowing stop mode is performed by displacing the fin body 30 toward the upstream side and bringing the tapered portion 33 into contact with the narrow portion 23 to block the narrow portion 23.

When the area of the blowout port 22 is at its smallest, the flow speed becomes high at the blowout port 22 located closest to the occupant, and the range where the air hits the occupant is also narrow, so that strong air hits the occupant. The area of the blowout port 22 is not narrowed, the narrow portion 23 is formed on the upstream side, and the air is divided into two airflows between the narrow portion 23 and the blowout port 22 by the fin body 30 (tapered portion 33). The two divided airflows are blown out from the blowout port 22 in directions away from each other upward and downward; however, since parts of the two airflows are suctioned into the central region, the air diffuses and is blown out over a wide range including the central region. Therefore, the strength of the air hitting the occupant can be adjusted to a moderate strength, so that comfort can be improved.

Referring to FIG. 3, in a second aspect, in the air-conditioning outlet device 10 according to the first aspect, the inner walls 66a and 68a extending from the narrow portion 23 to the blowout port 22 along the fin body 30 are formed inside the housing 20. The blown air can be smoothly guided from the narrow portion 23 to the blowout port 22.

In a third aspect, in the air-conditioning outlet device 10 according to the first or second aspect, a width of the fin body 30 in the second direction is smaller than a width of the short sides 22b of the blowout port 22 (refer to FIG. 1). The flow path from the narrow portion 23 to the blowout port 22 can be ensured without being further narrowed.

In a fourth aspect, in the air-conditioning outlet device 10 according to any one of the first to third aspects, the fin body 30 is displaceable toward the upstream side along the air blowing direction. The fin body 30 can also be used at any intermediate position between the position in FIG. 7A and the position in FIG. 7B (between the most downstream position and the position where the fin body 30 comes into contact with the narrow portion 23).

In a fifth aspect, in the air-conditioning outlet device 10 according to the fourth aspect, the fin body 30 is displaced toward the upstream side and comes into contact with an inner wall of the flow path, so that the flow path can be blocked and air blowing can be stopped. Since air blowing is controlled by operating the fin body 30 parallel to the air blowing direction (≈substantially parallel to the line of sight) upstream of the blowout port, switching can be performed between an air-blowing state and an air-blowing stop state without changing the appearance.

Referring to FIG. 4, in a sixth aspect, in the air-conditioning outlet device 10 according to any one of the first to fifth aspects, the first fin mechanism 40 includes the first motor 41 that generates a driving force in a rotation direction when energized, and the rack 46 that converts the driving force of the first motor 41 into a motion in a linear direction. The fin body 30 is connected to the rack 46. The fin body 30 can be moved to a more accurate position.

Referring to FIG. 5, in a seventh aspect, the air-conditioning outlet device 10 according to any one of the first to sixth aspects further includes the second fin mechanism 50 for displacing the fin body 30 in the second direction. The air blowing direction can be adjusted by displacing the fin body 30 in the second direction.

In an eighth aspect, in the air-conditioning outlet device 10 according to the seventh aspect, the second fin mechanism 50 includes the second motor 51 that generates a driving force in a rotation direction when energized, and the fin support 56 that is displaced in the second direction by the driving force of the second motor 51 and that can support the fin body 30. The fin body 30 can be moved to a more accurate position.

In a ninth aspect, in the air-conditioning outlet device 10 according to the eighth aspect, the fin support 56 includes the linear gear 56d in which the teeth are linearly disposed so as to be displaced linearly in the second direction, and the arc gears 56e in which the teeth are disposed in an arc shape so as to be displaced in an arc shape in the second direction, and the linear gear 56d and the arc gears 56e are continuously formed. The fin body 30 can be displaced linearly in the second direction and can be rotated. The air can be blown in a wider variety of directions.

Referring to FIG. 6, in a tenth aspect, the air-conditioning outlet device 10 according to any one of the first to ninth aspects further includes the air guide mechanism 60 that is provided to be displaceable toward the fin body 30, and that guides the direction of the air blown out from the blowout port 22. The air guide mechanism 60 includes guide fins 66 and 68 that extend along the fin body 30 and that are displaceable toward the fin body 30. The air direction around the fin body 30 can be adjusted by displacing the guide fins 66 and 68.

In an eleventh aspect, in the air-conditioning outlet device 10 according to the tenth aspect, the downstream ends (refer to the guide fin end surfaces 66b and 68b) of the guide fins 66 and 68 have a shape conforming to the peripheral edge of the blowout port 22 of the housing 20. In the central air-blowing mode, the inside of the housing 20 is hidden, so that the appearance can be improved. Furthermore, dust or objects can be prevented from entering the inside of the movable wall storage 26, and fingers can be prevented from being pinched.

In a twelfth aspect, in the air-conditioning outlet device 10 according to the tenth or eleventh aspect, the air guide mechanism 60 includes the second motor 51 as a drive source, and swings the guide fins 66 and 68 using the drive force of the second motor 51. The position of the guide fins can be adjusted more precisely.

Referring to FIG. 6, in a thirteenth aspect, in the air-conditioning outlet device 10 according to any one of the tenth to twelfth aspects, the air guide mechanism 60 includes the second motor 51 as a drive source, the drive gear 51a that rotates when driven by the second motor 51, and the driven gears 62 to 64 that are rotatable when the drive gear 51a rotates. In at least some of the driven gears 62 to 64, all the teeth mesh with each other at a portion corresponding to the arc gear 56e, and a driving force of the drive gear 51a is not transmitted to the air guide mechanism 60 at a portion corresponding to the linear gear 56d.

A single motor can be shared with the second fin mechanism 50 and can be linked to the second fin mechanism 50, and a region where the driving force is not transmitted can be formed by not forming teeth in part.

Referring to FIG. 8A and FIG. 8B, in a fourteenth aspect, in the air-conditioning outlet device 10 according to any one of the tenth to thirteenth aspects, the guide fins 66 and 68 can come into contact with the tapered portion 33. The air can be blown from only one side of the fin body 30 by bringing the guide fin 66 or 68 into contact with the fin body 30.

Referring to FIG. 8B and FIG. 9B, in a fifteenth aspect, in the air-conditioning outlet device 10 according to any one of the tenth to twelfth aspects, the guide fins 66 and 68 are displaceable onto an extension line of the upstream flow path. When one of the guide fins 66 and 68 is displaced onto the extension line of the upstream flow path (from the narrow portion 23) and the other is displaced into the movable wall storage portion 26, the air parallel to the upstream flow path is blown out from the blowout port 22.

The air-conditioning outlet devices according to the invention may be disposed not only in the front portion of the passenger compartment but may also be provided in a console, a ceiling, pillars, and the like. If the air guide mechanism 60 is not provided, the inner walls 66a and 68a may be formed by the housing 20. In this case, the movable wall storage 26 is not required.

The invention is not limited to the embodiment as long as the actions and effects of the invention are exhibited.

What is claimed is:

1. An air-conditioning outlet device comprising:
a housing into which air is blown, and in which a blowout port that blows out the air is formed at a downstream end of the housing with reference to a flow direction of the blown air; and
a fin body displaceably provided inside the housing,
wherein the housing includes a narrow portion having an area narrower than an area of the blowout port,
the blowout port has a substantially rectangular shape, and
when a direction parallel to long sides of the blowout port is defined as a first direction and a direction parallel to short sides that are sides shorter than the long sides is defined as a second direction, the fin body is provided along the first direction, is located between the blowout port and the narrow portion in a normal mode, and includes a tapered portion of which a width in the second direction increases as the tapered portion extends from an upstream side toward a downstream side.

2. The air-conditioning outlet device according to claim 1,
wherein inner walls extending from the narrow portion to the blowout port along the fin body are formed inside the housing.

3. The air-conditioning outlet device according to claim 1,
wherein a width of the fin body in the second direction is smaller than a width of the short sides of the blowout port.

4. The air-conditioning outlet device according to claim 1, further comprising:
a first fin mechanism that displaces the fin body along an air blowing direction.

5. The air-conditioning outlet device according to claim 4,
wherein the fin body is switchable between air blowing and air blowing stop, and when a state where the blowing out of the air from the blowout port is stopped is defined as an air-blowing stop mode, a change from the normal mode to the air-blowing stop mode is performed by displacing the fin body toward the upstream side to block a flow path.

6. The air-conditioning outlet device according to claim 4,
wherein the first fin mechanism includes a first motor that generates a driving force in a rotation direction when energized, and a rack that converts the driving force of the first motor into a motion in a linear direction, and
the fin body is connected to the rack.

7. The air-conditioning outlet device according to claim 4, further comprising:
a second fin mechanism for displacing the fin body in the second direction.

8. The air-conditioning outlet device according to claim 7,
wherein the second fin mechanism includes a second motor that generates a driving force in a rotation direction when energized, and a fin support that is displaced in the second direction by the driving force of the second motor and that can support the fin body.

9. The air-conditioning outlet device according to claim 8,
wherein the fin support includes a linear gear in which teeth are linearly disposed so as to be displaced linearly in the second direction, and an arc gear in which teeth are disposed in an arc shape so as to be displaced in an arc shape in the second direction, and the linear gear and the arc gear are continuously formed.

10. The air-conditioning outlet device according to claim 4, further comprising:
an air guide mechanism that is provided to be displaceable toward the fin body, and that guides a direction of the air blown out from the blowout port,
wherein the air guide mechanism includes guide fins that extend along the fin body and that are displaceable toward the fin body.

11. The air-conditioning outlet device according to claim 10,
wherein downstream ends of the guide fins have a shape conforming to a peripheral edge of the blowout port of the housing.

12. The air-conditioning outlet device according to claim 10, further comprising:
a second fin mechanism for displacing the fin body in the second direction,
wherein the second fin mechanism includes a second motor that generates a driving force in a rotation direction when energized, and a fin support that is displaced in the second direction by the driving force of the second motor and that can support the fin body, and
the air guide mechanism includes the second motor as a drive source, and swings the guide fins using the drive force of the second motor.

13. The air-conditioning outlet device according to claim 10, further comprising:
a second fin mechanism for displacing the fin body in the second direction,
wherein the second fin mechanism includes a second motor that generates a driving force in a rotation direction when energized, and a fin support that is displaced in the second direction by the driving force of the second motor and that can support the fin body,
the air guide mechanism includes the second motor as a drive source, a drive gear that rotates when driven by the second motor, and driven gears that are rotatable when the drive gear rotates, and
in at least some of the driven gears, teeth are formed only in a portion excluding a portion corresponding to the linear gear, and a driving force of the drive gear is not transmitted at the portion corresponding to the linear gear.

14. The air-conditioning outlet device according to claim 10,
wherein the guide fins can come into contact with the tapered portion.

15. The air-conditioning outlet device according to claim 10,
wherein the guide fins are displaceable to an angle parallel to the first direction.
